(19) United States
(12) Patent Application Publication
(10) Pub. No.: US 2017/0361595 A1
(43) Pub. Date: Dec. 21, 2017

(54) EXPANDABLE FILM

(71) Applicant: Cryovac, Inc., Charlotte, NC (US)

(72) Inventors: Ranganathan Soundararajan, Simpsonville, SC (US); Anthony Cooke, Fairforest, SC (US); Andy Kisner, Marietta, SC (US); Blaine Clemons Childress, Inman, SC (US); Joseph E. Owensby, Spartanburg, SC (US); Billy Wayne Austin, Duncan, SC (US); Steven Ensley, Lyman, SC (US)

(21) Appl. No.: 15/534,567

(22) PCT Filed: Dec. 4, 2015
(86) PCT No.: PCT/US2015/063964

§ 371 Date: Jun. 9, 2017

Related U.S. Application Data
(60) Provisional application No. 62/090,576, filed on Dec. 11, 2014.

(51) Int. Cl. B32B 27/40; A43B 23/02; B32B 3/26; B32B 5/02; B32B 27/12; A43B 13/04; B32B 5/22; B32B 27/08; B32B 27/32

(52) U.S. Cl. CPC B32B 27/40; B32B 27/08; A43B 23/0215; B32B 3/266; B32B 27/32; B32B 27/12; A43B 13/04; B32B 5/22; B32B 5/026; B32B 2307/536; B32B 2307/72; B32B 2437/02

(57) ABSTRACT

An expandable film includes a core layer and first and second non-expandable outer layers. The core layer includes expandable microspheres dispersed in a matrix having at least 40% of one or more matrix polymers selected from (i) ethylene/unsaturated ester copolymer having an unsaturated ester comonomer content of from 20% to 60%, (ii) ethylene/alpha-olefin copolymer having a density of less than 0.915 g/cc, and (iii) combinations thereof. The melting point of the one or more matrix polymers is at least 15° C. below the activation temperature of the expandable microspheres. The first and second non-expandable outer layers each independently include one or more thermoplastic polymers having a melting point at least 15° C. below the activation temperature of the expandable microspheres.

This application claims the benefit of U.S. Provisional Patent Application Ser. No. 62/090,576 filed Dec. 11, 2014, which is incorporated herein in its entirety by reference.

The presently disclosed subject matter relates to an expandable film, for example, an expandable useful in the manufacture of shoe components.

### BACKGROUND

In a common method of manufacturing shoe components—such as the shoe upper, inner flat sole with cushioning, and inner heel portion of a sports shoe—a relatively thick, soft polyurethane foam is adhesively laminated on each face with a knit polyester fabric. The resulting fabric/foam/fabric is heated and compression molded to a desired shape having a much reduced thickness relative the original thickness of the foam. Thus the foam does not expand during the process, but is compressed. In so doing, the polyurethane foam does not express or penetrate through the exterior fabric layers, because of the nature of the foam.

However, a process of expanding (rather than compressing) a foam in a mold presents a much different situation. The use of a sheet having a heat-activated expandable foam characteristic as a component of an assembly having, for example, a knit polyester fabric adjacent the sheet, can undesirably result in penetration or bleed through of the expanded foam into or through the fabric material as the sheet expands or foams. Further, the relatively deep draw required by the heel portion of an inner sole of a shoe component presents a difficult challenge to provide a uniform wall thickness while avoiding undesirable thinning or breakage in that region. Also, the resulting shoe piece must have acceptable softness and flexibility attributes.

### SUMMARY

One or more embodiments of the presently disclosed subject matter address one or more of the aforementioned problems.

An expandable film includes a core layer and first and second non-expandable outer layers. The core layer includes a matrix having at least 40%, by weight of the matrix, of one or more matrix polymers selected from (i) ethylene/unsaturated ester copolymer having an unsaturated ester comonomer content of from 20% to 60%, based on the weight of the copolymer, (ii) ethylene/alpha-olefin copolymer having a density of less than 0.915 g/cc, and (iii) combinations thereof. Expandable microspheres are dispersed in the matrix. The expandable microspheres have an activation temperature. The melting point of the one or more matrix polymers is at least 15° C. below the activation temperature of the expandable microspheres. The first and second non-expandable outer layers each independently include one or more thermoplastic polymers having a melting point at least 15° C. below the activation temperature of the expandable microspheres.

These and other objects, advantages, and features of the presently disclosed subject matter will be more readily understood and appreciated by reference to the detailed description and the drawings.

### DETAILED DESCRIPTION

Embodiments of the disclosed subject matter include an expandable film comprising a core layer and first and second non-expandable outer layers. The core layer comprises expandable microspheres dispersed in a matrix of one or more matrix polymers.

The expandable film may comprise at least any one of the following numbers of layers: 3, 4, 5, 7, 9; and may comprise at most any one of the following numbers of layers: 3, 4, 5, 8, 10, and 15. The term “layer” refers to a discrete film component, which is substantially coextensive with the film and has a substantially uniform formulation, composition, or configuration. Where two or more directly adjacent layers are essentially the same, then these two or more adjacent layers may be considered a single layer for the purposes of this application.

The expandable film may have a total thickness (before expansion) of at least, and/or at most, any of the following: 3, 5, 8, 10, 13, 15, 18, 20, and 25 mils. The film after expansion (i.e., the expanded film, as discussed below in more detail) may have a total thickness of at least, and/or at most, any of the following: 40, 60, 80, 100, 120, 140, 160, 180 mils. The ratio of the thickness of the expanded film (i.e., after expansion) to the expandable film (i.e., before expansion (i.e., the “expansion ratio”) may be at least, and/or at most, any of the following: 4:1, 5:1, 6:1, 7:1, 8:1, 10:1, 15:1, and 20:1.

The expandable film may define a plurality of perforations, which may help to provide a breathable attribute to the expandable film and the corresponding expanded film (after expansion). The plurality of perforations of the expandable film (i.e., before expansion) may have an average perforation diameter of at least any of the following: 2 mm, 2.25 mm, 2.5 mm, 2.75 mm, 3 mm, 3.5 mm, 4 mm, 4.5 mm, and 5 mm; and/or at most any of the following: 6 mm, 5 mm, 4.5 mm, 4 mm, 3.5 mm, 3 mm, 2.75 mm, 2.5 mm, and 2.25 mm.

### Core Layer(s)

The expandable film comprises one or more internal layers. As used herein, an “internal layer” is a layer of the film that is between two other layers of the film. A “core layer” is an internal layer of the film that comprises microspheres (expandable microspheres before expansion, and expanded microspheres after expansion). The expandable film may comprise one core layer, or may comprise one or more core layers. For example, the expandable film may comprise at least, and/or at most, any of the following number of core layers: 1, 2, 3, 4, 5, and 8. The expandable film may also comprise one or more internal layers that are not core layers.

A core layer may have a thickness of at least, and/or at most, any of the following: 20, 30, 40, 50, 60, 70, 80, 90, and 95%, relative the total thickness of the expandable film. If the expandable film comprises more than one core layer, then the total thickness of the core layers may be at least, and/or at most, any of the following: 30, 40, 50, 60, 70, 80, 90, and 95%, relative the total thickness of the expandable film.

The melting point of a core layer may be below the activation temperature of the expandable microspheres by at least any one of the following amounts: 15° C., 20° C., 25° C., 30° C., 35° C., 40° C., 45° C., 50° C., 55° C., 60° C., and 65° C. For example, if the activation temperature of the expandable microspheres is 138° C., and the melting point of the core layer is below the activation temperature of the expandable microspheres by at least 15° C., then the melting point of the core layer is below 123° C. (i.e., 138° C. minus 15° C.).

### Expandable Microspheres of the Core Layer(s)

A core layer of the expandable film comprises expandable microspheres dispersed in a matrix.

Expandable microspheres comprise a thermoplastic barrier shell encapsulating a fluid (e.g., liquid isobutane or isobutene). The thermoplastic shell of the microsphere, having a spherical shape, maintains the encapsulated fluid under conditions resulting in a liquid phase. When the thermoplastic shell is heated above its glass transition temperature (i.e., the activation temperature of the microsphere), the shell softens and the encapsulated fluid changes from a liquid to a gaseous state, thus dramatically expanding the volume of the microsphere (e.g., a 40 times increase in volume). Once the system cools down, the expanded microsphere shell hardens again, but the encapsulated gas does not return to a liquid state, so that the expansion is permanent.

The expansion of the expandable microsphere occurs at the activation temperature of the expandable microsphere. Because the shell of the microsphere may comprise a composite of several thermoplastics having varying phase change characteristics, the activation temperature may be reported as a range. However, as used herein, the activation temperature is the lower end of the effective temperature range for initiating the microsphere expansion (i.e., for the onset of activation of expansion of the microspheres). The expandable microspheres of the core layer may have an activation temperature, for example, selected from at most, and/or at least, any of the following: 76° C., 80° C., 95° C., 105° C., 120° C., 122° C., 135° C., 138° C., 145° C., 150° C., and 160° C.

The expandable microspheres may be characterized as closed expandable cells, which once expanded maintain the expanded encapsulated fluid, but do not absorb water through the thermoplastic shell. Further, the expanded microspheres may provide a resiliency to withstand several cycles of loading/unloading without breaking.

The expandable microspheres of a core layer may have a size (i.e., diameter) of at least, and/or at most, any of the following: 5, 10, 15, 20, 30, 40, and 50 microns. The expanded microspheres of a core layer may have a size (i.e., diameter) of at least, and/or at most, any of the following: 15, 20, 30, 40, 60, 80, 100, 120, and 160 microns.

For example, the shell thickness of an expandable microsphere may go from 2 microns before expansion to 0.1 microns after expansion; and in such case the expandable microsphere having a size (diameter) of 12 microns, and the corresponding expanded microsphere will have a size (diameter) of 40 microns after expansion.

Expandable microspheres are commercially available, for example, from Akzo Nobel under the Expancel family trade name. Once expanded, the Expancel expanded microspheres may have a density ranging from 24 and 70 kg/m³. The Expancel expanded microsphere sizes include 20, 40, 80 and 120 μm (diameter). The Expancel 461 DU 20 microsphere has a size (diameter) of from 6 to 9 μm before expansion and about 20 μm after expansion. The Expancel 920 DU 120 microsphere has a size (diameter) of from 28 to 38 μm before expansion and about 120 μm after expansion.

A core layer of the expandable film may comprise expandable microspheres in an amount, based on the weight of the core layer, of at least any one of the following: 1, 2, 3, 4, 5, 6, 7, 8, 9, and 10%. A core layer may comprise expandable microspheres in an amount, based on the weight of the core layer, of at most any one of the following: 2, 3, 4, 5, 6, 7, 8, 9, 10, and 15%.

### Matrix Polymers of the Core Layer(s)

A core layer of the expandable film comprises a matrix, which is the thermoplastic polymer in which the expandable microspheres are dispersed to surround and support the expandable microspheres. The matrix comprises one or more of matrix polymers described herein. The matrix polymers have a melt strength sufficient to support the expanded microspheres in the matrix melt so that the resulting foam (i.e., expanded core layer resulting in an expanded film) does not collapse during expansion of the expandable microspheres in the melt. Further, the matrix polymers contribute acceptable feel attributes (e.g., flexibility and softness) to the resulting expanded film and expanded piece incorporating the expanded film.

The matrix polymers of the matrix are melt processable at a temperature below the activation temperature of the expandable microspheres. For example, the melting point of the one or more matrix polymers is below the activation temperature of the expandable microspheres by at least any one of the following amounts: 15° C., 20° C., 25° C., 30° C., 35° C., 40° C., 45° C., 50° C., 55° C., 60° C., and 65° C. For example, if the activation temperature of the expandable microspheres is 138° C., and the melting point of the one or more matrix polymers of the matrix is below the activation temperature of the expandable microspheres by at least 15° C., then the melting point of the one or more matrix polymers is below 123° C. (i.e., 138° C. minus 15° C.).

Further, the melting point of the one or more matrix polymers may be at most, and/or at least, any of the following: 95, 90, 85, 80, 75, and 70° C. All references to the melting point or melting temperature of a polymer, a resin, or a film layer in this application refer to the melting peak temperature of the dominant melting phase of the polymer, resin, or layer as determined by differential scanning calorimetry according to ASTM D-3418.

The melt index value (also called the melt flow rate) of the one or more matrix polymers may be at most, and/or at least, any of the following: 20, 25, 12, 10, 8, 5, 4, 3, 2, 1.5, and 1 g/10 minutes. All references to melt index values in this application are measured by ASTM D1238, which is incorporated herein in its entirety by reference, under Condition 190/2.16, unless the ASTM test method specifies a different temperature and piston weight for the material.

The matrix may comprise at least any one the following amounts of any of the one or more matrix polymers described herein: 40%, 50%, 60%, 70%, 80%, 85%, 90%, 95%, and 100%; and/or at most any one of the following amounts of any of the one or more matrix polymers described herein: 100%, 95%, 90%, 85%, 80%, 70%, 60%, and 50%, by weight of the matrix. For example, the matrix may comprise at least 80% and at most 95% of one or more matrix polymers, by weight of the matrix.

A core layer may comprise the matrix in an amount of at least any one of the following: 60%, 70%, 80%, 90%, 95%, and 98%; and/or at most any one of the following: 99%, 98%, 95%, 90%, 80%, and 70%, by weight of the core layer.

The matrix may comprise one or more thermoplastic polymers other than the matrix polymers described herein (i.e., “other thermoplastic polymers”). Such other thermoplastic polymers include, for example, thermoplastic polyurethane. The matrix may comprise such other thermoplastic polymers in at least any one the following amounts: 5, 10, 15, 20, 30, 40%, and 50%; and/or at most any one of the following amounts: 60%, 50%, 40%, 30%, 20%, 10%, and 5%, by weight of the matrix. The matrix may be free from thermoplastic polymers other than the one or more matrix polymers.

The one or more matrix polymers of a core layer may be selected from one or more of the following:

(i) ethylene/unsaturated ester copolymer having an unsaturated ester comonomer content of from 20% to 60%, based on the weight of the copolymer;

(ii) ethylene/alpha-olefin copolymer having a density of less than 0.915 g/cc; and

(iii) combinations thereof.

“Copolymer” as used herein means a polymer derived from two or more types of monomers, and includes terpolymers, etc.

### Ethylene/Unsaturated Ester Copolymer

The one or more matrix polymers may comprise ethylene/unsaturated ester copolymers having an unsaturated ester comonomer content of from 20% to 60%, based on the weight of the copolymer. Ethylene/unsaturated ester copolymer is a copolymer of ethylene and one or more unsaturated ester comonomers. The unsaturated ester comonomers may be selected from: 1) vinyl esters of aliphatic carboxylic acids, where the esters have from 4 to 12 carbon atoms, and 2) alkyl esters of acrylic or methacrylic acid (collectively, “alkyl (meth)acrylate”), where the esters have from 4 to 12 carbon atoms.

For example, the unsaturated ester comonomer may be a vinyl ester of aliphatic carboxylic acid (i.e., the “vinyl ester” monomer) selected from one or more of vinyl acetate, vinyl propionate, vinyl hexanoate, and vinyl 2-ethylhexanoate. The vinyl ester monomer may have any of from 4 to 8 carbon atoms, from 4 to 6 carbon atoms, from 4 to 5 carbon atoms, and 4 carbon atoms (i.e., vinyl acetate monomer). Accordingly, for example, the ethylene/unsaturated ester copolymer may be selected from any one or more of ethylene/vinyl acetate copolymer, ethylene/vinyl propionate copolymer, ethylene/vinyl hexanoate copolymer, and ethylene/vinyl 2-ethylhexanoate copolymer.

Also by way of example, the unsaturated ester comonomer may be an alkyl (meth)acrylate selected from one or more of methyl acrylate, ethyl acrylate, isobutyl acrylate, n-butyl acrylate, hexyl acrylate, 2-ethylhexyl acrylate, methyl methacrylate, ethyl methacrylate, isobutyl methacrylate, n-butyl methacrylate, hexyl methacrylate, and 2-ethylhexyl methacrylate. The alkyl (meth)acrylate monomer may have any of from 4 to 8 carbon atoms, from 4 to 6 carbon atoms, and from 4 to 5 carbon atoms. Accordingly, for example, the ethylene/unsaturated ester copolymer may be selected from any one or more of ethylene/methyl (meth)acrylate copolymer and ethylene/ethyl (meth)acrylate copolymer.

The unsaturated ester (i.e., vinyl ester or alkyl (meth)acrylate) comonomer content of the ethylene/unsaturated ester copolymer may be at least any of the following: 20, 22, 25, 28, 30, 35, 40, and 50%; and/or at most any of the following: 60, 50, 40, 35, 30, 28, 25, and 22%, based on the weight of the copolymer. The ethylene comonomer content of the ethylene/unsaturated ester copolymer may be at least, and/or at most, any of the following: 40, 50, 60, 70, and 80%, based on the weight of the copolymer.

By way of example, the one or more matrix polymers may be selected from one or more of ethylene/methyl acrylate copolymer, ethylene/methyl methacrylate copolymer, ethylene/ethyl acrylate copolymer, ethylene/ethyl methacrylate copolymer, ethylene/butyl acrylate copolymer, ethylene/2-ethylhexyl methacrylate copolymer, and ethylene/vinyl acetate copolymer, where each copolymer has an unsaturated ester comonomer content of from 20% to 60%, based on the weight of the copolymer.

An exemplary ethylene/methyl acrylate copolymer is available from Westlake Chemical under the EMAC SP2403 trade name having a 24% methyl acrylate comonomer content and a melting point of 75° C. and under the SP2206 trade name having a 24% methyl acrylate comonomer content and a melting point of 77° C. An exemplary ethylene/butyl acrylate copolymer is available from Westlake Chemical under the EBAC SP1806 trade name having a melting point of 91° C.

The matrix may comprise any of one or more of the ethylene/unsaturated ester copolymers having an unsaturated ester comonomer content of from 20% to 60%, based on the weight of the copolymer, as described herein (e.g., copolymers having comonomer of vinyl esters of aliphatic carboxylic acid or of alkyl (meth)acrylate) in at least any one the following amounts: 40%, 50%, 60%, 70%, 80%, 85%, 90%, 95%, and 100%; and/or in at most any one of the following amounts: 100%, 95%, 90%, 85%, 80%, 70%, 60%, and 50%, by weight of the matrix.

### Ethylene/Alpha-Olefin Copolymer

The one or more matrix polymers may comprise ethylene/alpha-olefin copolymer having a density of less than 0.915 g/cc. The ethylene/alpha-olefin copolymer of the one or more matrix polymers may have a density of at most any one of the following: 0.915, 0.910, 0.905, 0.900, 0.895, 0.890, 0.885, and 0.880 g/cc; and/or at least any one of the following: 0.855, 0.860, 0.865, 0.870, 0.875, 0.880, 0.885, 0.890, 0.895, and 0.900 g/cc. Unless otherwise indicated, all polymer densities herein are measured according to ASTM D1505.

Ethylene/alpha-olefin copolymer (EAO) are copolymers of ethylene and one or more alpha-olefins, the copolymer having ethylene monomer as the majority weight-percentage content. The comonomer of the EAOs of the one or more matrix polymers may include any one of the following: one or more C₃-C₂₀ α-olefins, one or more C₄-C₁₂ α-olefins, and one or more C₄-C₈ α-olefins. Useful α-olefins as comonomers include 1-butene, 1-hexene, 1-octene, and mixtures thereof. The EAOs of the one or more matrix polymers may comprise very-low density polyethylene (“VLDPE”), ultra-low density polyethylene (“ULDPE”), and plastomers.

The EAOs of the one or more matrix polymers may be heterogeneous copolymers, homogeneous copolymers, and mixtures thereof. As is known in the art, heterogeneous polymers have a relatively wide variation in molecular weight and composition distribution. Heterogeneous polymers may be prepared with, for example, conventional Ziegler-Natta catalysts.

On the other hand, homogeneous polymers are typically prepared using metallocene or other single-site catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from ExxonMobil under the EXACT trademark, linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

The matrix may comprise any of one or more of the ethylene/alpha-olefin copolymers having a density of less than 0.915 g/cc, based on the weight of the copolymer, as described herein, in at least any one the following amounts: 40%, 50%, 60%, 70%, 80%, 85%, 90%, 95%, and 100%; and/or in at most any one of the following amounts: 100%, 95%, 90%, 85%, 80%, 70%, 60%, and 50%, by weight of the matrix.

### Outer Layers

The expandable film comprises outer layers (i.e., skin layers) forming an outer surface of the film. The “outer layer” of a film is a layer that has only one side directly adhered to another layer of the film. For multilayered films, there inherently exist two outer layers of the film.

The expandable film comprises first and second non-expandable outer layers. As used herein in the context of first and second non-expandable outer layers, “non-expandable” means that the layer does not include expandable microspheres sufficient to provide a heat-activated expansion characteristic.

The first and second non-expandable outer layers function to help retain the expansion of the core layer from penetrating or bleeding into fabric that may be adjacent to the expandable film in an assembly.

Each of the first and second non-expandable outer layers may independently have a thickness of at least, and/or at most, any of the following: 1, 2, 4, 5, 7, 8, 10, and 15%, relative the total thickness of the expandable film.

The melting point of the first and second non-expandable outer layers is sufficiently low so as to not activate the expandable microspheres of a core layer during manufacture of the expandable film (e.g., during a coextrusion process). The melting point of the first and second non-expandable outer layers may each independently be below the activation temperature of the expandable microspheres of the core layer by at least any one of the following amounts: 15° C., 20° C., 25° C., 30° C., 35° C., 40° C., 45° C., 50° C., 55° C., 60° C., and 65° C.

The one or more thermoplastic polymers of the outer layers may be melt processable at a temperature below the activation temperature of the expandable microspheres in the core layer. The first and second non-expandable outer layers each independently comprise one or more thermoplastic polymers having a melting point at least 15° C. below the activation temperature of the expandable microspheres of the core layer, for example, below the activation temperature of the expandable microspheres by at least any one of the following amounts: 15° C., 20° C., 25° C., 30° C., 35° C., 40° C., 45° C., 50° C., 55° C., 60° C., and 65° C. The one or more thermoplastic polymers may be selected to contribute acceptable feel attributes (e.g., flexibility and softness) to the resulting expanded film and expanded piece incorporating the expanded film.

Further, the melting point of the first and second non-expandable outer layers, and/or the one or more thermoplastic polymers of the outer layers may independently be at most, and/or at least, any of the following: 95, 90, 85, 80, 75, and 70° C. The melt index value (also called the melt flow rate) of the one or more thermoplastic polymers of the outer layers may be at most, and/or at least, any of the following: 20, 25, 12, 10, 8, 5, 4, 3, 2, 1.5, and 1 g/10 minutes.

The one or more thermoplastic polymers of the outer layers may be selected from one or more of any of the ethylene/unsaturated ester copolymer discussed herein (e.g., discussed in conjunction with a core layer), from any of the ethylene/alpha-olefin copolymers discussed herein (e.g., discussed in conjunction with a core layer), as well as from other polyolefins such as ethylene homo- and co-polymers and propylene homo- and co-polymers, in any of the amounts relative the outer layer in which they reside, as set forth for the amounts of one or more matrix polymer relative the core layer in which they reside. The term “polyolefins” includes copolymers that contain at least 50 weight % monomer units derived from olefin.

The first and second non-expandable outer layers may each comprise at least any one the following amounts of any of the one or more thermoplastic polymers described herein: 50%, 60%, 70%, 80%, 85%, 90%, 95%, and 100%; and/or at most any one of the following amounts of any of the one or more thermoplastic polymers described herein: 100%, 95%, 90%, 85%, 80%, 70%, and 60%, by weight of the outside layer. For example, the first and second non-expandable outer layers may each independently comprise at least 50% of the one or more thermoplastic polymers having a melting point at least 15° C. below the activation temperature of the expandable microspheres, by weight of the outer layer.

The one or more thermoplastic polymer of the first non-expandable outer layer and/or the second non-expandable outer layer may each independently comprise the same type of thermopolymer as the one or more matrix polymers of the core layer, for example, in an amount of at least any of the following: 50%, 60%, 70%, 80%, 90%, 95%, and 100%, based on the weight of the outer layer.

### Manufacturing the Expandable Film

The expandable film may be manufactured by thermoplastic film-forming processes known in the art. The expandable film may be prepared by co-extrusion utilizing, for example, a tubular trapped bubble film process or a flat film (i.e., cast film or slit die) process. The expandable film may also be prepared by applying one or more layers by extrusion coating, adhesive lamination, extrusion lamination, and solvent-borne coating. A combination of these processes may also be employed. The expandable microspheres may be added into the melt stream of the core layer utilizing a masterbatch.

During manufacture of the expandable film, care is used to assure that the temperature of the melt stream in which the microspheres reside does not reach the activation temperature of the microspheres. Similarly, care is used so that the temperature of the first and second non-expandable outer layers during processing does not transfer sufficient heat to activate the expansion of the microspheres in the core layer.

The expandable film may be perforated to define a plurality of perforations, as described herein.

The expandable film or one or more of the layers, such as the first and/or second non-expandable outer layers, of the expandable film may be cross-linked, for example, to improve the strength of the film. Cross-linking may be achieved by using chemical additives or by subjecting one or more film layers to one or more energetic radiation treatments—such as ultraviolet, or ionizing radiation such as X-ray, gamma ray, beta ray, and electron beam—to induce cross-linking between molecules of the irradiated material. Useful ionizing radiation dosages include at least, and/or at most, any of the following: 5, 7, 10, 15, 20, 25, 30, 35, 40, 45, 50, 55, 60, 65, 70, 75, 80, 90, 100, 110, 120, 130, and 150 kGy (kiloGrey). Useful energies for the electron beam range may be selected from any one of the following: 70 to 250 keV, from 150 to 250 keV, from 100 to 150 keV, and from 70 to 100 keV. The electron beam radiation may be applied utilizing an electron curtain to irradiate the film.

### Use of the Film

The expandable film may be expanded to be an expanded film by heating the expandable film to the activation temperature of the expandable microspheres so that the microspheres expand. The expandable film may be used in the manufacture of molded pieces, for example, a molded shoe piece or part such as the shoe upper, inner sole, and heel portion of the upper or inner sole of a sports shoe, or for example, in the manufacture of sporting apparel such as a sports bra.

In manufacture of a molded piece, the expandable film may be placed in a mold having a bottom female mold and a corresponding top male mold. Either or both of the top and bottom molds may be heated to a desired temperature to transfer heat to the expandable film. For example, the film may be placed over the open bottom (female) mold, and the top male mold (e.g., corresponding in shape to the female mold) may be lowered to form a gap—that is, a distance between the surface of the cavity of the female bottom mold and the surface of the top male mold—in which the expandable film resides and can expand upon reaching the activation temperature of the expandable microspheres in the core layer(s).

An assembly may be made having the expandable film sandwiched between a fabric on one or both sides of the expandable film, for example, to create a fabric/film/fabric assembly having a first fabric adjacent a first side of the expandable film and a second fabric adjacent the opposite second side of the expandable film. The assembly may be positioned in a mold and expanded as discussed above with respect to the expandable film.

The fabric may comprise any of polyester, polyamide, polyester-polyurethane copolymer (e.g., spandex, Lycra, or elastane), or other apparel fabrics, and be in a configuration such as, for example, a knitted fabric (e.g., knitted polyester fabric).

Prior shoe components have used an open cell polyurethane foam, which has desirably high breathability (i.e., relatively air flow permeation), but tends to undesirably uptake water, for example, when the shoe is exposed to rain or other moisture conditions. However, the expanded film of the presently disclosed subject matter acts as a closed cell foam, which avoids the water uptake issue of open-cell polyurethane foam components.

Further, the expandable film and/or assembly may be perforated (e.g., by any of needle perforation and laser perforation) to define a plurality of perforations, which may help to provide a breathable attribute to the expandable assembly and the corresponding expanded assembly (after expansion). The use of laser perforation may be less likely to activate the expandable microspheres adjacent the perforation compared to hot needle perforation. The plurality of perforations of the expandable film and/or expandable assembly (i.e., before expansion) may have an average perforation diameter of at least any of the following: 2 mm, 2.25 mm, 2.5 mm, 2.75 mm, 3 mm, 3.5 mm, 4 mm, 4.5 mm, and 5 mm; and/or at most any of the following: 6 mm, 5 mm, 4.5 mm, 4 mm, 3.5 mm, 3 mm, 2.75 mm, 2.5 mm, and 2.25 mm. Also, the expandable film and/or expandable assembly may have any of such perforations in an areal density of at least, and/or at most, any of the following: 1, 2, 3, 4, 5, 6, 7, 8, 9, and 10 perforations per square inch.

We have surprisingly and unexpectedly found that the expandable film may be perforated as discussed herein without closure of the perforations during subsequent expansion of the film. The size and number of the perforations may be selected so that the expanded film does not suffer appreciably from water uptake as with open cell polyurethane foam, but provide sufficient breathability through the expanded film to meet the air respiration needs of products incorporating the expanded film. Further, the expanded film when used, for example, as a shoe component, may provide a lighter weight relative to the polyurethane foam of comparable existing shoe components.

The Asker C hardness of the resulting expanded film and/or the assembly incorporating the expanded film, may be at least any one of the following: 30, 40, 50, 60, and 70; and/or at most any one of the following: 80, 70, 60, 50, and 40. The Asker C hardness is determined by use of a durometer according to ASTM D2240-05 at room temperature. A durometer for measurement of Type Asker C is available, for example, from Kobunshi Keiki Co. Ltd.

### EXAMPLES

The following examples are presented for the purpose of further illustrating and explaining the presently disclosed subject matter and are not to be taken as limiting in any regard. Unless otherwise indicated, all parts and percentages are by weight.

The following abbreviations are used in the examples:

“EVA1” is an ethylene/vinyl acetate copolymer having a vinyl acetate comonomer content of 26.7%, a melting point of 72° C., a melt flow rate of 5.75 g/10 minutes (190/2.16), and a density of 0.95 g/cc available from ExxonMobil under the Escorene LD 761.36 trade name.

“EVA2” is an ethylene/vinyl acetate copolymer having a vinyl acetate comonomer content of 18.5%, a melting point of 86° C., a melt flow rate of 2.55 g/10 minutes (190/2.16), and a density of 0.942 g/cc, available from ExxonMobil under the Escorene Ultra LD 721.1K trade name.

“EVA3” is an ethylene/vinyl acetate copolymer having a vinyl acetate comonomer content of 8.7% (i.e., from 8.4 to 9.0%), a melting point of 99° C., a melt flow rate of 2.0 g/10 minutes (190/2.16), and a density of 0.930 g/cc, available from ExxonMobil under the Escorene LD 318.92 trade name.

“FMB1” is a master batch having a 65 weight % concentration of expandable microspheres in an ethylene/vinyl acetate copolymer carrier. It is available from Akzo Nobel under the Expancel 950 MB 80 trade name. The microspheres have about an 80 micron size (diameter) after expansion and an 18 to 24 micron size (diameter) before expansion. The activation temperature is about 138° C.

“FMB2” is a master batch having a 65 weight % concentration of expandable microspheres in an ethylene/vinyl acetate copolymer carrier. It is available from Akzo Nobel under the Expancel 951 MB 120 trade name. The microspheres have about a 120 micron size (diameter) after expansion and an 28 to 38 micron size (diameter) before expansion. The activation temperature is about 133° C.

“FMB3” is a master batch having a 65 weight % concentration of expandable microspheres in an ethylene/vinyl acetate copolymer carrier. It is available from Akzo Nobel under the Expancel 980 MB 120 trade name. The microspheres have about a 120 micron size (diameter) after expansion and a 25 to 40 micron size (diameter) before expansion. The activation temperature is about 158° C.

“CFA1” is a olefinic masterbatch (pellet concentrate) of an endothermic (heat absorbing) chemical foaming (blowing) agent having a bulk density of from 0.55 to 0.75 g/cc, a decomposition temperature of 158° C., and a total gas evolution of about 100 ml/gram available from Reedy International under the Safoam FPE-50 trade name.

“TPU1” is an amorphous, polyester-based grade of thermoplastic polyurethane available from Huntsman Corporation under the Irogran PS456-202 trade name. It has a melt index of 40 g/10 minutes (177 C/2.16 kg) and a specific gravity of 1.18 (ASTM D-792).

“PO1” is a very low density polyethylene, namely a single-site catalyzed ethylene/octene copolymer having a density of 0.870 g/cc (ASTM D792), a melt index of 5.0 g/10 minutes (190° C./2.16 kg) (ASTM D1238), a vicat softening temperature of 45° C. (ASTM D1525), and a melting point (DSC) of 63° C. available from Dow under the Affinity EG 8200G trade name.

“PO2” is a very low density polyethylene, namely a single-site catalyzed ethylene/octene copolymer having a density of 0.875 g/cc, a melting point of 66° C., and a melt flow rate of 3.0 g/10 minutes (190/2.16) available from Dow under the Engage 8452 trade name.

“PO3” is a very low density polyethylene, namely a single-site catalyzed ethylene/octene copolymer having a density of 0.882 g/cc, a melting point of 70° C., and a melt flow rate of 1.1 g/10 minutes (190/2.16) available from ExxonMobil under the Exact 8201 trade name.

“PO4” is a very low density polyethylene, namely a single-site catalyzed ethylene/octene copolymer having a density of 0.885 g/cc, a melting point of 78° C., a Vicat softening point of 63° C., and a melt flow rate of 1 g/10 minutes (190/2.16) available from Dow under the Engage 8003 trade name.

### Examples

Three-layer films (Films 1 to 16 and 18 to 31) were co-extruded to have a total thickness of 15 mils, except for Film 7, which had a total thickness of 8 mils. The layer arrangement was 1/2/3, with layers 1 and 3 as outer layers on either side of the inner layer 2. The outer layers 1 and 3 of each film had the same composition, namely 100% of the component identified in the Tables 1 to 4 for the layer. Each of layers 1 and 3 had a thickness of 10% of total film thickness (i.e., 1.5 mils thick, except for Film 7 having a layer 1 and 3 thickness of 0.8 mils each). The inner layer 2 had the composition (as % of total weight of layer 2) as shown in the Tables 1 to 4. The thickness of layer 2 was 80% of the total thickness of the film (i.e., 12 mils, except for Film 7 having a layer 2 thickness of 6.4 mils).

During extrusion, the melt temperature of the Layer 2 mix containing the FMB1, FMB2, or FMB3 microspheres was kept well below the activation temperature for expanding the microspheres, in order to avoid premature expansion of the microspheres. The target temperature range for these melt streams were from 110° C. to 120° C. (i.e., from 13° C. to 48° C. units below the activation temperature of the microspheres).

A knitted polyester fabric having a nominal thickness of 20 mils was placed on both sides of the film to sandwich the film between the fabric layers to create an assembly of fabric/film/fabric having a total thickness of 55 mils (except for the assembly using Film 7, such assembly having a total thickness of 48 mils). The area size of the assembly was approximately 13.5 inch by 13.5 inch.

The resulting assembly was molded as follows using a mold having a bottom female mold and a corresponding top male mold. The female mold had an opening or cavity in the shape of the heel cup portion of the inner sole of a men's size 8 shoe, with the bottom of the heel portion at the lowest point of the mold cavity. This resulted in a mold having a 65 mm deep pocket at the heel portion. The temperature readings were taken via thermocouples drilled into the center of the top and bottom molds.

The top and bottom molds were heated to the temperature shown in the Tables. The assembly (fabric/film/fabric) was placed over the open bottom (female) mold. The top male mold (corresponding in shape to the female mold) was lowered to form a gap—that is, a distance between the surface of the cavity of the female bottom mold and the surface of the top male mold—as set forth in Table 1, with the fabric/film/fabric assembly within the gap between the top and bottom molds.

The mold was held in this heated and gapped condition for the amount of “mold time” reported in Tables 1 to 3 while the heat transferred from the top and bottom molds caused the microspheres within the film to expand and create a foamed piece between the top and bottom molds. At the expiration of the mold time, the mold was opened, the resulting molded piece was removed, the thickness of the resulting fabric/expanded foam/fabric molded piece was measured in the toe area of the molded piece, and reported as “expanded thickness” in Tables 1 to 3.

The molded pieces resulting from Films 1 to 9 (Table 1) were examined by hand and found to be sufficiently soft and stretchy to indicate desirable characteristics for use in shoe wear. Further, the foam filled through the heel section without collapse to provide an acceptable piece.

TABLE 1

| | | | | Top | | | |
|---|---|---|---|---|---|---|---|
| | | | Bottom | mold | Mold | Expanded | |
| | Outer Layers | Inner Layer 2 | mold | temp | time | thickness | Mold gap |
| Film | 1&3 | (wt % of layer) | temp (° F.) | (° F.) | (min) | (mils) | (mils) |
| 1 | EVA1 | EVA1 - 68% | 350 | 275 | 3 | 158 | 375 |
| | | TPU1 - 22% | | | | | |
| | | FMB1 - 10% | | | | | |
| 1 | above | above | 350 | 275 | 3 | 167 | 220 |
| 1 | above | above | 350 | 275 | 2.5 | 165 | 220 |
| 2 | EVA1 | EVA1 - 45% | 350 | 275 | 3 | 154 | 375 |
| | | TPU1 - 45% | | | | | |
| | | FMB1 - 10% | | | | | |
| 2 | above | above | 350 | 275 | 3 | 124 | 220 |
| 2 | above | above | 350 | 275 | 2.5 | 118 | 220 |
| 3 | EVA1 | EVA1 - 22% | 350 | 275 | 3 | 151 | 375 |
| | | TPU1 - 68% | | | | | |
| | | FMB1 - 10% | | | | | |
| 3 | above | above | 350 | 275 | 3 | 161 | 220 |
| 3 | above | above | 350 | 275 | 2.5 | 131 | 220 |
| 4 | PO1 | PO1 - 45% | 350 | 275 | 3 | 120 | 375 |
| | | EVA1 - 45% | | | | | |
| | | FMB1 - 10% | | | | | |
| 4 | above | above | 350 | 275 | 3 | 141 | 375 |
| 4 | above | above | 350 | 275 | 2.5 | 105 | 375 |
| 5 | PO2 | PO2 - 45% | 350 | 275 | 3 | 150 | 375 |
| | | EVA1 - 45% | | | | | |
| | | FMB1 - 10% | | | | | |
| 5 | above | above | 350 | 275 | 3 | 161 | 220 |
| 5 | above | above | 350 | 275 | 2.5 | 141 | 220 |
| 6 | EVA1 | EVA1 - 90% | 350 | 275 | 3 | 143 | 220 |
| | | FMB1 - 10% | | | | | |
| 7 | EVA1 | EVA1 - 90% | 350 | 275 | 3 | 150 | 220 |
| | | FMB1 - 10% | | | | | |
| 8 | EVA1 | EVA1 - 45% | 350 | 275 | 3 | 167 | 220 |
| | | PO4 - 45% | | | | | |
| | | FMB1 - 10% | | | | | |
| 9 | EVA1 | EVA1 - 45% | 350 | 275 | 3 | 164 | 220 |
| | | PO3 - 45% | | | | | |
| | | FMB1 - 10% | | | | | |

The Asker C Hardness of the molded piece of Film 1 was 61, of Film 4 was 58, of Film 4 was 61, and of Film 5 was 57.

The molded pieces resulting from Films 10 to 16 and 18 (Table 2) were examined by hand and found to be harder and have much less of a stretch attribute than the molded pieces formed from Films 1 to 9 above, such that the molded pieces resulting from the Films 10 to 16 were found to be unacceptable for use as shoe pieces.

TABLE 2

| | Outer | | Bottom | Top mold | Mold | Expanded | |
|---|---|---|---|---|---|---|---|
| | Layers | Inner Layer 2 | mold | temp | time | thickness | Mold gap |
| Film | 1&3 | (wt % of layer) | temp (° F.) | (° F.) | (min) | (mils) | (mils) |
| 10 | EVA2 | EVA2 - 92.5% | 350 | 275 | 3 | 140 | 220 |
| | | FMB1 - 7.5% | | | | | |
| 11 | EVA2 | EVA2 - 90% | 350 | 275 | 3 | 160 | 220 |
| | | FMB1 - 10% | | | | | |
| 12 | EVA2 | EVA2 - 85% | 350 | 275 | 3 | 126 | 220 |
| | | FMB1 - 10% | | | | | |
| | | CFA1 - 5% | | | | | |
| 13 | EVA2 | EVA2 - 82.5% | 350 | 275 | 3 | 140 | 220 |
| | | FMB1 - 10% | | | | | |
| | | CFA1 - 7.5% | | | | | |
| 14 | EVA2 | EVA2 - 82.5% | 350 | 275 | 3 | 130 | 220 |
| | | FMB1 - 7.5% | | | | | |
| | | CFA1 - 10% | | | | | |
| 15 | EVA2 | EVA2 - 80% | 350 | 275 | 3 | 163 | 220 |
| | | FMB1 - 10% | | | | | |
| | | CFA1 - 10% | | | | | |
| 16 | EVA2 | EVA2 - 85% | 350 | 275 | 3 | 109 | 220 |
| | | FMB1 - 7.5% | | | | | |
| | | CFA1 - 7.5% | | | | | |
| 18 | EVA3 | EVA3 - 95% | 350 | 275 | 3 | 115 | 245 |
| | | FMB1 - 5% | | | | | |

The molded pieces resulting from Films 18 to 23 (Table 3) were examined by hand and found to be harder than the molded pieces formed from Films 1 to 9 above, and did not have stretch attribute, such that the molded pieces resulting from the Films 18 to 23 were found to be unacceptable for use as shoe pieces.

TABLE 3

| | | | Bottom | Top | | | | |
|---|---|---|---|---|---|---|---|---|
| | Outer | | mold | mold | Mold | Expanded | Mold | |
| | Layers | Inner Layer 2 | temp | temp | time | thickness | gap | |
| Film | 1&3 | (wt % of layer) | (° F.) | (° F.) | (min) | (mils) | (mils) | Comment |
| 18 | EVA3 | EVA3 - 95% | 350 | 350 | 3 | 56 | 70 | B |
| | | FMB1 - 5% | | | | | | |
| 19 | EVA3 | EVA3 - 90% | 350 | 350 | 3 | 70 | 70 | B |
| | | FMB1 - 10% | | | | | | |
| 20 | EVA3 | EVA3 - 85% | 350 | 350 | 3 | 70 | 70 | B |
| | | FMB1 - 15% | | | | | | |
| 21 | EVA3 | EVA3 - 92.5% | 350 | 350 | 3 | 70 | 70 | B |
| | | FMB1 - 7.5% | | | | | | |
| 22 | EVA2 | EVA2 - 90% | 350 | 275 | 3 | 102 | 375 | C |
| | | CFA1 - 10% | | | | | | |
| 22 | above | above | 350 | 275 | 3 | 88 | 220 | C |
| 23 | PO3 | EVA2 - 90% | 350 | 275 | 3 | 160 | 375 | B |
| | | FMB1 - 10% | | | | | | |
| 23 | above | above | 350 | 275 | 3 | N/M | 245 | B |
| 23 | above | above | 350 | 275 | 3 | 134 | 220 | B |

“B” means that the molded piece did not result in a sufficiently formed heel portion.
“C” means that the expanded film failed to create a molded piece.
“N/M” means not measured.

The molded pieces resulting from Films 24 to 31 (Table 4) were examined by hand and found to be sufficiently soft and stretchy to indicate desirable characteristics for use in shoe wear. Further, the foam filled through the heel section without collapse to provide an acceptable piece.

TABLE 4

| | Outer | | Bottom | Top mold | | Expanded | |
|---|---|---|---|---|---|---|---|
| | Layers | Inner Layer 2 | mold temp | temp | Mold time | thickness | Mold gap |
| Film | 1&3 | (wt % of layer) | (° F.) | (° F.) | (min) | (mils) | (mils) |
| 24 | EVA1 | EVA1 - 90% | 350 | 350 | 3 | N/M | 220 |
| | | FMB2 - 10% | | | | | |
| 25 | EVA1 | EVA1 - 95% | 350 | 350 | 3 | N/M | 220 |
| | | FMB2 - 5% | | | | | |
| 26 | EVA1 | EVA1 - 97.5% | 350 | 350 | 3 | N/M | 220 |
| | | FMB2 - 2.5% | | | | | |
| 27 | EVA1 | EVA1 - 87.5% | 350 | 350 | 3 | N/M | 220 |
| | | PU1 - 2.5% | | | | | |
| | | FMB2 - 10% | | | | | |
| 28 | EVA1 | EVA1 - 92.5% | 350 | 350 | 3 | N/M | 220 |
| | | PU1 - 2.5% | | | | | |
| | | FMB2 - 5% | | | | | |
| 29 | EVA1 | EVA1 - 90% | 350 | 350 | 3 | N/M | 220 |
| | | FMB3 - 10% | | | | | |
| 30 | EVA1 | EVA1 - 68% | 350 | 350 | 3 | N/M | 220 |
| | | PU1 - 22% | | | | | |
| | | FMB3 - 10% | | | | | |
| 31 | EVA1 | EVA1 - 79% | 350 | 350 | 3 | N/M | 220 |
| | | PU1 - 11% | | | | | |
| | | FMB3 - 10% | | | | | |

“N/M” means not measured.

### Perforated Expandable Film Examples

Several assemblies (Samples 32-39) of fabric/film/fabric having a total thickness of 55 mils were made having knitted polyester fabric having a nominal thickness of 20 mils on both sides of the 15 mils thick expandable film (i.e., Film 1 above) to sandwich the film between the fabric layers to create the assembly, having a total thickness of 48 mils. The area size of the assembly was approximately 13.5 inch by 13.5 inch.

The samples of the assemblies were laser perforated before any expansion of the expandable film to have 900 holes of the size shown in Table 5. The holes were spaced in the sample in an array of 30 perforations×30 perforations.

Each of the resulting perforated assemblies were molded as described above, so that the expandable film expanded to create an expanded assembly comprising the expanded film. The air flow rate (indicating amount of breathability) through the expanded assembly was measured utilizing a Frazier Air Permeability Tester according to ASTM D-737 and reported in Table 5. The air flow rate was also tested for two unperforated expanded assemblies and found to have no measureable air flow rate. The air flow rates were also measured for two commercially-available perforated shoe uppers (Compare 1 &2) having hole diameters of about 3 to 4 mm. Compare 1&2 utilized compressed polyurethane foam adhesively laminated on each face with a knit polyester fabric. The measured air flow rate was 28.2 cfm/sf for Compare 1 and 51 cfm/sf for Compare 2.

TABLE 5

| | | Air Flow Rate | | |
|---|---|---|---|---|
| | Diameter of | (cfm/sf) | | |
| | holes before | Before | After | |
| Sample | expansion (mm) | Expansion | Expansion | Comments |
| 32 | 0.88 | N/M | 0 | X |
| 33 | 1.02 | N/M | 0 | X |
| 34 | 2.2 | N/M | 0 | X |
| 35 | 6 | 87.8 | 46.1 | Y |
| 36 | 5 | 60.5 | 37.0 | Y |
| 37 | 3 | 14.5 | 25.8 | Z |
| 38 | 2.25 | 11.0 | 22.6 | Z |
| 39 | 2 | 6.5 | 57.4 | Z |

“N/M” means not measured.
“X” means that the holes closed during expansion of expandable film.
“Y” means that the holes did not close during expansion and the air flow rate decreased after expansion of the film.
“Z” means that it was surprising and unexpected that the air flow rate increased after expansion of the film.

### Various Embodiments

Various and additional embodiments of the disclosed subject matter are described and recited in the following sentences A through QQQ.

A. An expandable film comprising:

a core layer comprising:
a matrix comprising at least 40%, by weight of the matrix, of one or more matrix polymers selected from the group consisting of (i) ethylene/unsaturated ester copolymer having an unsaturated ester comonomer content of from 20% to 60%, based on the weight of the copolymer, (ii) ethylene/alpha-olefin copolymer having a density of less than 0.915 g/cc, and (iii) combinations thereof; and
expandable microspheres dispersed in the matrix, wherein the expandable microspheres have an activation temperature, and the melting point of the one or more matrix polymers is at least 15° C. below the activation temperature of the expandable microspheres; and

first and second non-expandable outer layers each independently comprising one or more thermoplastic polymers having a melting point at least 15° C. below the activation temperature of the expandable microspheres.

B. The expandable film of sentence A wherein the core layer comprises the matrix in an amount of at least any one of 60%, 70%, 80%, 90%, and 98%, by weight of the core layer.
C. The expandable film of any one of the previous sentences wherein the core layer comprises the matrix in an amount of at most any one of 98%, 95%, 90%, 80%, and 70%, by weight of the core layer.
D. The expandable film of any one of the previous sentences wherein the melting point of the one or more matrix polymers is below the activation temperature of the expandable microspheres by at least any one of the following amounts: 15° C., 20° C., 25° C., 30° C., 35° C., 40° C., 45° C., 50° C., 55° C., 60° C., and 65° C.
E. The expandable film of any one of the previous sentences wherein the melting point of the one or more matrix polymers may be at most any one of the following: 95, 90, 85, 80, 75, and 70° C.
F. The expandable film of any one of the previous sentences wherein the melting point of the one or more matrix polymers may be at least any one of the following: 95, 90, 85, 80, 75, and 70° C.
G. The expandable film of any one of the previous sentences wherein the melt index value of the one or more matrix polymers may be at most any one of the following: 20, 25, 12, 10, 8, 5, 4, 3, 2, 1.5, and 1 g/10 minutes.
H. The expandable film of any one of the previous sentences wherein the melt index value of the one or more matrix polymers may be at least any one of the following: 20, 25, 12, 10, 8, 5, 4, 3, 2, 1.5, and 1 g/10 minutes.
I. The expandable film of any one of the previous sentences wherein the matrix comprises element (i) in at least any one the following amounts: 40%, 50%, 60%, 70%, 80%, 85%, 90%, 95%, and 100%, by weight of the matrix.
J. The expandable film of any one of the previous sentences wherein the matrix comprises element (i) in at most any one the following amounts: 100%, 95%, 90%, 85%, 80%, 70%, 60%, and 50%, by weight of the matrix.
K. The expandable film of any one of sentences I and J wherein the unsaturated ester comonomer of element (i) is selected from vinyl ester of aliphatic carboxylic acids, where the esters have from 4 to 12 carbon atoms.
L. The expandable film of sentence K wherein the unsaturated ester comonomer of element (i) is selected from any of one or more of vinyl acetate, vinyl propionate, vinyl hexanoate, and vinyl 2-ethylhexanoate.
M. The expandable film of sentence K wherein the unsaturated ester comonomer of element (i) is selected from vinyl ester monomers having any one or more of from 4 to 8 carbon atoms, from 4 to 6 carbon atoms, and from 4 to 5 carbon atoms.
N. The expandable film of any one of sentences I and J wherein the unsaturated ester comonomer of element (i) is selected from alkyl (meth)acrylates having from 4 to 12 carbon atoms.
O. The expandable film of sentence N wherein the alkyl (meth)acrylate is selected from one or more of methyl acrylate, ethyl acrylate, isobutyl acrylate, n-butyl acrylate, hexyl acrylate, 2-ethylhexyl acrylate, methyl methacrylate, ethyl methacrylate, isobutyl methacrylate, n-butyl methacrylate, hexyl methacrylate, and 2-ethylhexyl methacrylate.
P. The expandable film of sentence N wherein the alkyl (meth)acrylate comonomer has an amount of carbon atoms selected from one or more of from 4 to 8 carbon atoms, from 4 to 6 carbon atoms, and from 4 to 5 carbon atoms.
Q. The expandable film of any one of sentences I to P wherein the unsaturated ester comonomer content of the element (i) is at least any one of the following: 22, 25, 28, 30, 35, 40, and 50%, based on the weight of the copolymer.
R. The expandable film of sentence Q wherein the unsaturated ester comonomer content of the element (i) is at most any one of the following: 50, 40, 35, 30, 28, 25, and 22%, based on the weight of the copolymer.
S. The expandable film of any one of sentences A to H wherein the matrix comprises element (ii) in at least any one the following amounts: 40%, 50%, 60%, 70%, 80%, 85%, 90%, 95%, and 100%, by weight of the matrix.
T. The expandable film of any one of sentences A to H and K wherein the matrix comprises element (ii) in at most any one the following amounts: 100%, 95%, 90%, 85%, 80%, 70%, 60%, and 50%, by weight of the matrix.
U. The expandable film of any one of sentences S to T wherein element (ii) has a density of at most any one of the following: 0.910, 0.905, 0.900, 0.895, 0.890, 0.885, and 0.880 g/cc.
V. The expandable film of sentence U wherein element (ii) has a density of at least any one of the following: 0.855, 0.860, 0.865, 0.870, 0.875, 0.880, 0.885, 0.890, 0.895, and 0.900 g/cc.
W. The expandable film of any one of sentences S to T wherein element (ii) is selected from one or more of very-low density polyethylene, ultra-low density polyethylene, and plastomer.
X. The expandable film of any one of sentences S to W wherein element (ii) is homogeneous.
Y. The expandable film of any one of the previous sentences wherein the thickness of the core layer is at least any one of the following: 20, 30, 40, 50, 60, 70, 80, 90, and 95%, relative the total thickness of the expandable film.
Z. The expandable film of any one of the previous sentences wherein the thickness of the core layer is at most any one of the following: 40, 50, 60, 70, 80, 90, and 95%, relative the total thickness of the expandable film.
AA. The expandable film of any one of the previous sentences wherein the melting point of the core layer is below the activation temperature of the expandable microspheres by at least any one of the following amounts: 15° C., 20° C., 25° C., 30° C., 35° C., 40° C., 45° C., 50° C., 55° C., 60° C., and 65° C.
BB. The expandable film of any one of the previous sentences having a total thickness before expansion of at least any one of the following: 3, 5, 8, 10, 13, 15, 18, 20, and 25 mils.
CC. The expandable film of any one of the previous sentences having a total thickness before expansion of at most any one of the following: 18, 20, and 25 mils.
DD. The expandable film of any one of the previous sentences, wherein the film thickness is expandable by an expansion ratio of at least any one of the following: 4:1, 5:1, 6:1, 7:1, 8:1, 10:1, 15:1, and 20:1.
EE. The expandable film of any one of the previous sentences wherein the expandable microspheres have an activation temperature selected from at most any one of the following: 80° C., 95° C., 105° C., 120° C., 122° C., 135° C., 138° C., 145° C., 150° C., and 160° C.
FF. The expandable film of any one of the previous sentences wherein the expandable microspheres have an activation temperature selected from at least any one of the following: 76° C., 80° C., 95° C., 105° C., 120° C., 122° C., 135° C., 138° C., 145° C., and 150° C.
GG. The expandable film of any one of the previous sentences wherein the expandable microspheres have a size of at least any one of the following: 5, 10, 15, 20, 30, and 40 microns.
HH. The expandable film of any one of the previous sentences wherein the expandable microspheres have a size of at most any one of the following: 10, 15, 20, 30, 40, and 50 microns.
II. The expandable film of any one of the previous sentences wherein the core layer comprises the expandable microspheres in an amount, based on the weight of the core layer, of at least any one of the following: 1, 2, 3, 4, 5, 6, 7, 8, 9, and 10%.
JJ. The expandable film of any one of the previous sentences wherein the core layer comprises the expandable microspheres in an amount, based on the weight of the core layer, of at most any one of the following: 2, 3, 4, 5, 6, 7, 8, 9, 10, and 15%.
KK. The expandable film of any one of the previous sentences wherein the first and second non-expandable outer layers each independently have a thickness of at least any of one of the following: 1, 2, 4, 5, 7, 8, and 10%, relative the total thickness of the expandable film.
LL. The expandable film of any one of the previous sentences wherein the first and second non-expandable outer layers each independently have a thickness of at most any of one of the following: 2, 4, 5, 7, 8, 10, and 15%, relative the total thickness of the expandable film.
MM. The expandable film of any one of the previous sentences wherein the melting point of the first and second non-expandable outer layers are each independently below the activation temperature of the expandable microspheres of the core layer by at least any one of the following amounts: 15° C., 20° C., 25° C., 30° C., 35° C., 40° C., 45° C., 50° C., 55° C., 60° C., and 65° C.
NN. The expandable film of any one of the previous sentences wherein the one or more thermoplastic polymers of the first and second non-expandable outer layers each independently have a melting point that is below the activation temperature of the expandable microspheres of the core layer by at least any one of the following amounts: 20° C., 25° C., 30° C., 35° C., 40° C., 45° C., 50° C., 55° C., 60° C., and 65° C.
OO. The expandable film of any one of the previous sentences wherein the one or more thermoplastic polymers of the first and second non-expandable outer layers are each independently selected from one or more of: (i) ethylene/unsaturated ester copolymer having an unsaturated ester comonomer content of from 20% to 60%, based on the weight of the copolymer, (ii) ethylene/alpha-olefin copolymer having a density of less than 0.915 g/cc, and (iii) combinations thereof.
PP. The expandable film of sentence OO wherein the first and second non-expandable outer layers each independently comprise at least any one the following amounts of the one or more thermoplastic polymers: 50%, 60%, 70%, 80%, 85%, 90%, 95%, and 100%, by weight of the outer layer
QQ. The expandable film of any one of sentences OO to PP wherein the first and second non-expandable outer layers each independently comprise at most any one the following amounts of the one or more thermoplastic polymers: 100%, 95%, 90%, 85%, 80%, 70%, and 60%, by weight of the outer layer.
RR. The expandable film of any one of the previous sentences wherein the one or more thermoplastic polymers of the first and second non-expandable outer layers are each independently selected from one or more of ethylene/vinyl acetate copolymer, ethylene/vinyl propionate copolymer, ethylene/vinyl hexanoate copolymer, ethylene/vinyl 2-ethylhexanoate copolymer, ethylene/methyl acrylate copolymer, ethylene/ethyl acrylate copolymer, ethylene/isobutyl acrylate copolymer, ethylene/n-butyl acrylate copolymer, ethylene/hexyl acrylate copolymer, ethylene/2-ethylhexyl acrylate copolymer, ethylene/methyl methacrylate copolymer, ethylene/ethyl methacrylate copolymer, ethylene/isobutyl methacrylate copolymer, ethylene/n-butyl methacrylate copolymer, ethylene/hexyl methacrylate copolymer, ethylene/2-ethylhexyl methacrylate copolymer, very-low density polyethylene, ultra-low density polyethylene, and plastomer.
SS. The expandable film of any one of the previous sentences wherein the one or more thermoplastic polymers of the first and second non-expandable outer layers are the same as the one or more matrix polymers of the core layer.
TT. The expandable film of any one of the previous sentences wherein the matrix further comprises thermoplastic polyurethane.
UU. The expandable film of sentence TT wherein the matrix comprises thermoplastic polyurethane in at least any one the following amounts: 5, 10, 15, 20, 30, 40%, and 50%; and/or at most any one of the following amounts: 60%, 50%, 40%, 30%, 20%, 10%, and 5%, by weight of the matrix.
VV. The expandable film of any one of the previous sentences wherein the expandable film comprises at least any one of the following numbers of layers: 3, 4, 5, 7, 9.
WW. The expandable film of any one of the previous sentences wherein the expandable film comprises at most any one of the following numbers of layers: 3, 4, 5, 8, 10, and 15.
XX. The expandable film of any one of the previous sentences wherein the expandable film comprises only three layers.
YY. The expandable film of any one of the previous sentences wherein the expandable film defines a plurality of perforations.
ZZ. The expandable film of sentence YY wherein the plurality of perforations have an average perforation diameter of at least any one of the following: 2 mm, 2.25 mm, 2.5 mm, 2.75 mm, 3 mm, 3.5 mm, 4 mm, 4.5 mm, and 5 mm.
AAA. The expandable film of any one of sentences YY and ZZ wherein the plurality of perforations have an average perforation diameter of at most any one of the following: 6 mm, 5 mm, 4.5 mm, 4 mm, 3.5 mm, 3 mm, 2.75 mm, 2.5 mm, and 2.25 mm.
BBB. The expandable film of any one of sentence YY to AAA wherein the plurality of perforations have an areal density of at least, and/or at most, any of the following: 1, 2, 3, 4, 5, 6, 7, 8, 9, and 10 perforations per square inch.
CCC. A method of making the expandable film of any one of the previous sentences, the method comprising coextruding the first and second non-expandable outer layers with the core layer.
DDD. A method of making the expandable film of any one of sentences A to BBB, the method comprising extrusion coating the first and second non-expandable outer layers onto the core layer.
EEE. A method of making the expandable film of any one of sentences A to BBB, the method comprising laminating the first and second non-expandable outer layers onto the core layer.
FFF. The method of sentence EEE wherein the lamination step is selected from adhesive lamination and heat lamination.
GGG. The method of any one of sentences CCC to FFF further comprising:

perforating the expandable film to provide a perforated expandable film.

HHH. The method of sentence GGG wherein the perforating step comprises laser perforating the expandable film.
III. A method of making an expanded film, the method comprising:

placing the expandable film of any one of sentences A to BBB in a mold; and

heating the film within the mold to expand the expandable film to create an expanded film.

JJJ. The method of sentence III wherein the expanded film has a thickness relative to the thickness of the expandable film of at least any one of the following: 4:1, 5:1, 6:1, 7:1, 8:1, 10:1, 15:1, and 20:1.
KKK. The method of any one of sentences III to JJJ wherein the expanded film has an Asker C hardness of at most any one of 80, 70, 60, 50, and 40.
LLL. The method of any one of sentences III to KKK wherein the expanded film has an Asker C hardness of at least any one of 30, 40, 50, 60, and 70.
MMM. A shoe part comprising the expanded film of any one of sentences III to LLL.
NNN. An expandable assembly comprising:

the expandable film of any one of sentences A to BBB;

a first fabric adjacent a first side of the film; and

a second fabric adjacent a second side of the film.

OOO. A method of making an expanded assembly, the method comprising:

placing the expandable assembly of sentence NNN in a mold; and

heating the expandable assembly within the mold to expand the expandable assembly to create an expanded assembly.

PPP. A method of making an expanded film, the method comprising:

placing the perforated expandable film of any one of sentences YY to BBB in a mold; and

heating the film within the mold to expand the expandable film to create an expanded perforated film.

QQQ. The method of sentence PPP wherein the expanded perforated film has a permeation air flow rate of at least any one of the following: 10, 15, 20, 25, 30, 35, and 40 cubic feet per minute per square foot.

Any numerical value ranges recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions are those of various embodiments of the invention. Various alterations and changes can be made without departing from the spirit and broader aspects of the various embodiments of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

1. An expandable film comprising:
a core layer comprising:
a matrix comprising at least 40%, by weight of the matrix, of one or more matrix polymers selected from the group consisting of (i) ethylene/unsaturated ester copolymer having an unsaturated ester comonomer content of from 20% to 60%, based on the weight of the copolymer, (ii) ethylene/alpha-olefin copolymer having a density of less than 0.915 g/cc, and (iii) combinations thereof; and
expandable microspheres dispersed in the matrix, wherein the expandable microspheres have an activation temperature, and the melting point of the one or more matrix polymers is at least 15° C. below the activation temperature of the expandable microspheres; and
first and second non-expandable outer layers each independently comprising one or more thermoplastic polymers having a melting point at least 15° C. below the activation temperature of the expandable microspheres.

2. The expandable film of claim 1 wherein the melting point of the one or more matrix polymers is below the activation temperature of the expandable microspheres by at least 20° C.

3. The expandable film of claim 1 wherein the melting point of the one or more matrix polymers is at most 95° C.

4. The expandable film of claim 1 wherein the melting point of the one or more matrix polymers is at least 70° C.

5. The expandable film of claim 1 wherein the matrix comprises element (i) in at least 40% by weight of the matrix.

6. The expandable film of claim 5 wherein the matrix comprises element (i) in at most 90%, by weight of the matrix.

7. The expandable film of claim 5 wherein the unsaturated ester comonomer of element (i) is selected from vinyl ester of aliphatic carboxylic acids, where the esters have from 4 to 12 carbon atoms.

8. The expandable film of claim 5 wherein the unsaturated ester comonomer of element (i) is selected from alkyl (meth)acrylates having from 4 to 12 carbon atoms.

9. The expandable film of claim 1 wherein the matrix comprises element (ii) in at least 40% by weight of the matrix.

10. The expandable film of claim 9 wherein the matrix comprises element (ii) in at most 90% by weight of the matrix.

11. The expandable film of claim 10 wherein element (ii) has a density of at most 0.910 g/cc.

12. (canceled)

13. The expandable film of claim 1 wherein the thickness of the core layer is at least 20%, relative the total thickness of the expandable film.

14. The expandable film of claim 13 wherein the thickness of the core layer is at most 80%, relative the total thickness of the expandable film.

15. The expandable film of claim 1 wherein the melting point of the core layer is below the activation temperature of the expandable microspheres by at least 15° C.

16.-17. (canceled)

18. The expandable film of claim 1 wherein the expandable microspheres have a size of from 5 to 50 microns.

19. (canceled)

20. The expandable film of claim 1 wherein the core layer comprises the expandable microspheres in an amount, based on the weight of the core layer, of from 1 to 15%.

21.-23. (canceled)

24. The expandable film of claim 1 wherein the matrix further comprises thermoplastic polyurethane.

25. The expandable film of claim 1 wherein the expandable film defines a plurality of perforations.

26.-27. (canceled)

28. A method of making an expanded film, the method comprising:
placing the expandable film of claim 1 in a mold; and
heating the film within the mold to expand the expandable film to create an expanded film.

29.-31. (canceled)

32. An expandable assembly comprising:
the expandable film of claim 1;
a first fabric adjacent a first side of the film; and
a second fabric adjacent a second side of the film.

33. (canceled)
